(19) United States
(12) Patent Application Publication
(10) Pub. No.: US 2020/0300140 A1
(43) Pub. Date: Sep. 24, 2020

(54) SELECTIVE CATALYTIC REDUCTION SYSTEM AND A METHOD FOR NOx REDUCTION

(71) Applicant: HANS JENSEN GREENTECH APS, Hadsund (DK)

(72) Inventor: Ole FANØE, Ålborg (DK)

(21) Appl. No.: 16/768,120

(22) PCT Filed: Nov. 29, 2018
(86) PCT No.: PCT/DK2018/050315

§ 371 Date: May 29, 2020

(30) Foreign Application Priority Data
Dec. 1, 2017 (DK) PA 2017 00681

(51) Int. Cl. F01N 3/20; F01N 3/08; F02B 75/02; F01N 3/28; F01N 5/02; B01D 53/94

(52) U.S. Cl. CPC F01N 3/208; B01D 2255/9202; F02B 75/02; F01N 3/28; F01N 5/02; B01D 53/9418; B01D 53/9431; B01D 53/9468; B01D 53/9477; F02B 2075/025; F02B 2075/027; F01N 2610/1453; F01N 2370/02; B01D 2255/504; B01D 2255/2047; B01D 2255/2065; B01D 2255/20715; B01D 2255/20761; B01D 2255/20738; B01D 2255/407; B01D 2255/65; B01D 2255/902; F01N 3/0842

(57) ABSTRACT

A selective catalytic reduction system applying diesel oil as reductant for converting nitrogen oxides by means of a catalyst into diatomic nitrogen and water in a diesel engine is provided. The selective catalytic reduction system includes an oil injection system, a reactor and a number of selective catalytic reduction catalysts provided in a first section. The selective catalytic reduction system includes at least one additional section including a number of selective catalytic reduction catalysts. The at least one additional section is provided in a non-zero from the first section.

### CROSS-REFERENCE TO RELATED APPLICATIONS

This application claims priority to PCT Application No. PCT/DK2018/050315, having a filing date of Nov. 29, 2018, which is based on DK Application No. PA 2017 00681, having a filing date of Dec. 1, 2017, the entire contents both of which are hereby incorporated by reference.

### FIELD OF TECHNOLOGY

The following relates to a selective catalytic reduction system for NOx reduction. The following also relates to a method for NOx reduction. The system and method are configured for selective catalytic reduction of NOx in an exhaust stream either after a four-stroke diesel engine or between the exhaust receiver and the exhaust turbines on a two-stroke diesel engine by using a multifunctioning catalyst with oil as reductant.

### BACKGROUND

Selective catalytic reduction systems are used for converting nitrogen oxides, typically referred to as NOx by means of a catalyst into diatomic nitrogen, N₂ and water, H₂O. The conventional art teaches that a gaseous reductant may be selected among the following: anhydrous ammonia, aqueous ammonia or urea, and may be added to a stream of flue or exhaust gas and be adsorbed onto a catalyst.

Commercial selective catalytic reduction systems are applied in diesel engines, such as those found on ships, diesel locomotives, gas turbines, large utility boilers, industrial boilers, and municipal solid waste boilers and have been shown to effectively reduce NOx.

The increasing environmental awareness regarding NOx emissions has introduced higher requirements for NOx reduction equipment.

It is known that the International Maritime Organization (IMO) gradually has introduced more restrained NOx emission standards. Likewise, NOx emission tax in countries like Norway and Sweden has raised the demand for NOx reduction equipment. Selective Catalytic Reduction systems using urea as reactant followed by Exhaust Gas Recirculation are commonly used.

For the automobile industry, the requirements for the NOx reduction equipment is far more demanding than for the marine industry including NOx reduction at temperatures up 700° C. and here zeolites are more stable than conventional material for catalyst powder typically V₂O₅/WO₃—TiO₂, therefore the interest in using zeolite-based catalysts.

Research has been carried out in order to find a method, in which diesel oil can be used as reductant instead of urea. In 1990, Dr. M. Iwamoto published information about using Cu-ZSM-5 (A Cu exchanged zeolite catalyst) as catalyst and diesel oil as reductant. (Dr. M. Iwamoto (M Iwamoto, Decomposition of NO on copper ion-exchanged zeolite catalysts, Proceedings of meeting on Catalytic technology for removal of nitrogen monoxide, Tokyo, January 1990, p. 17) found that Cu-ZSM-5 (Copper ion-exchanged zeolites) is fairly active in NOₓ reduction, if O₂ is present, and hydrocarbons used in the tests were C₂H₄, C₃H₆ and C₃H.

In 1996, S. Matsumoto (S. Matsumoto, Toyota, DeNOx catalyst for automotive lean burn engine; Catalysis Today 29 (1996) 43-45) concluded that, “the durability of Cu-ZSM-5 is insufficient for practical use” and introduced the NOx Storage Reduction catalyst (NSR catalyst) consisting of: “precious metals, alkaline earth metals, alumina and some other metal oxides”. Toyota has continued to develop the NSR system now called DiAir System (K. Yoshida et al., Toyota, Development of NSR and DiAir System to Achieve Clean Emission under Transient Cycle; SAE International 2014-01-2809) with pulsating HC injection during desulfation. However, others have continued developing the ZSM-5 catalyst.

It was disclosed (S. A. Yashnik et all, The Cu-ZSM-5 Catalysts Washcoated on Monolith for Diesel Emission Control; Chemistry for Sustainable Development 11 (2003) 309-319), that the Cu-ZSM-5 catalyst has a number of weaknesses, including losses of activity in gas with water and high temperature as well as losses, gradually, of activity with sulphur in the gas. Besides, it might be a problem, that half oxidized carbonous connections stick to the catalyst.

Research has found that, adding of Ce to Cu-ZSM-5 will increase the wet gas activity and hereby prevent formation of CuO, which reduces the activity.

US20070149385A1 discloses a system for reduction of NOx emission from diesel engines using catalysts with diesel oil as reductant. The system applies a multi-functioning catalyst for cracking of diesel oil, NOx reduction and a catalytic partial oxidation material including a platinum-group metal comprises an element selected from the group consisting of rhodium, platinum, iridium, palladium, osmium, and ruthenium to convert coke deposits to hydrogen and carbon monoxide. One disadvantage of this system is, that it requires use of precious metals which are expensive.

Thus, there is a need for an improved selective catalytic reduction system and selective catalytic reduction method for NOx reduction based on application of diesel oil as reductant, wherein a precious metal is not a requirement.

EP1111212A2 describes a selective catalytic NOx reduction system for Diesel engine exhaust applying Diesel oil as reductant. The system comprises a diesel oil injector, a selective catalytic reduction reactor and several selective catalytic reduction sections arranged in series. The catalyst sections each contain several catalyst layers. The distance between adjacent sections are, however, very short. Therefore, the system does not provide an optimum solution for NOx reduction.

### SUMMARY

An aspect relates to an improved selective catalytic reduction system and selective catalytic reduction method for NOx reduction based on application of diesel oil as reductant, wherein the system and the method reduces or even eliminates the above-mentioned disadvantages of the conventional art.

The selective catalytic reduction system according to embodiments of the invention is a selective catalytic reduction system configured for applying diesel oil as reductant for converting nitrogen oxides (NOx) by means of a catalyst into diatomic nitrogen (N₂) and water (H₂O) in a diesel engine, wherein the selective catalytic reduction system comprises:
an oil injection system;
a reactor;
a number of selective catalytic reduction catalysts provided in at least a first section comprising a plurality of layers and a second section comprising a plurality of layers, wherein the distance between the sections is larger than the thickness of the layers.

Hereby, it is possible to provide an improved selective catalytic reduction system and selective catalytic reduction method for NOx reduction based on application of diesel oil as reductant.

Having diesel oil as reactant eliminates the demand for tanks for storing urea on the ship, and eliminates potential complex logistics for supplying urea. The cost for oil injected is around the cost for urea injected. On four-stroke medium speed diesel engines around 75% of the energy content of the injected oil can be recovered in a down-stream installed exhaust gas boiler and used for production of water, electricity or heat, meaning the actual operation costs are down to 2% of the oil used for the diesel engine.

By diesel oil is meant a liquid fluid (containing fuel oil) configured to be used in diesel engines. Accordingly, the term diesel oil includes marine diesel oil, also referred to as “distillate marine diesel”, which is a blend of gasoil and heavy fuel oil, with less gasoil than intermediate fuel oil. The term diesel oil includes all fuel oil containing marine fuels.

Furthermore, the use of oil as reactant eliminates the risk of blocking the catalysts due to formation of ammonia-bisulphate (NH₄)HSO₄ or ammonium sulphate (NH₄)₂SO₄.

The reactor of the selective catalytic reduction system according to embodiments of the invention is weighing around 40% less than a conventional urea-SCR reactor with catalysts. Accordingly, embodiments of the invention makes it possible to reduce the reactor weight.

The process starts at an exhaust temperature of about 320° C. to about 360° C., such as about 350° C., but can continue operating at an exhaust temperature down to 310° C., because the process causes a temperature increase.

The length of the pipe for reactant injection and evaporation can be as short as one fifth of the urea selective catalytic reduction system pipe and can be made in conventional steel.

Two-stroke diesel engines, due to the temperature increase in the reactor according to embodiments of the invention require a marginal increase in diesel engine specific fuel consumption.

The selective catalytic reduction system according to embodiments of the invention is configured to convert nitrogen oxides (NOx) by means of a catalyst into diatomic nitrogen (N₂) and water (H₂O) in a diesel engine. The chemical process includes three integrated catalysing steps:
Cracking of the injected oil;
   Heterogeneous NOx conversion and formation of radicals used for a following reaction.
Homogeneous NOx conversion downstream of the catalyst.

During the cracking process, the reactant is injected into the exhaust as droplets upstream of the catalyst layer (of the sections) in a manner in which minimum 80% of the droplets have evaporated before reaching the first catalyst layer (of the first section).

The selective catalytic reduction system comprises structures configured to evenly disperse the oil into the exhaust.

The evaporated oil is cracked on the surface of the catalyst layers. A portion of the evaporated oil may, however, continue as un-cracked evaporated oil until it reaches the next catalyst layer. The temperature increases inside the reactor during the process carried out. Due to the increased temperature, only a minimum of the injected oil is passing through the system. The cracking takes place mainly on the surface of the catalyst layer. The cracking on the first layer is expected to be minimum 40%. Accordingly, it is advantageous to have several layers provided in a distance from each other.

The diesel oil contains relative long chained hydrocarbon connections. These hydrocarbon connections are cracked to short-chained hydrocarbon connections, during the catalyst process. These hydrocarbon connections are short enough to enter the catalyst layer of the sections. Accordingly, NO is converted to N₂ and H₂O, whereas radicals (NH4⁺) reacts with NO₂ that is converted to N₂ and H₂O. The likely chemical reactions (of the NOx conversion) are shown in the following.

The NO oxidation carried out may be expressed as:

NO+1/2O₂⇒NO₂ (1)

NO+NO₂+2H⁺⇒2NO++H₂O (2)

The heterogeneous catalyzing carried out may be expressed as:

2C₄H₈+10O₂+2NO⁺⇒N₂+2CO+6CO₂+8H₂O (3)

C₃H₆+NO⁺+2.5O₂⇒NH₄⁺CO+2CO₂+H₂O (4)

The homogeneous catalyzing carried out may be expressed as:

NH₄⁺+NO₂⇒N₂+2H₂O (5)

In an embodiment of the invention, the selective catalytic reduction system comprises catalyst powder being coated on substrates of honeycomb or corrugated material type. In an embodiment of the invention, the substrate comprises a ceramic material. In an embodiment of the invention, the substrate is zeolite. In embodiments of the invention, the substrate comprises a metal. In embodiments of the invention, the substrate is a metal. In embodiments of the invention, the substrate comprises a ceramic material. In embodiments of the invention, the substrate is a ceramic material.

The catalyst powder is typically added to the substrate by using a binder. The catalyst powder may comprise a ZSM-n type with n=5, 11 and others as well as modifications thereof. E.g. the copper (Cu) of the ZSM-n type catalyst may be exchanged with either iron (Fe) or magnesium (Mg). In an embodiment of the invention, the catalyst powder is provided as a coating at least covering the substrate.

In embodiments of the invention, the selective catalytic reduction system comprises catalyst powder, where one or more transition metals and one or more stabilizing metals are supported on a zeolite.

It may be beneficial that the zeolite is an alumina silicate.

The zeolite may include ZSM-5, ZSM-11, ZSM-12, Mordenite or Ferrerite.

The transition metal may include one or more of Cu, Fe and Mg.

The transition metal may further include one or more of Ce and Zr as stabilizing metals.

Cu may be added first and Ce and/or Zr may be added after a calcination or Ce and/or Zr may be added in the same operation.

Cu and Ce and/or Zr may be added in the same operation followed by a calcination at a temperature below 550° C.

Catalyst powder may be coated on a substrate of a honeycomb shape or corrugated plate shape, by using of a binder. The substrate may be of a metal type or a ceramic type.

In an embodiment of the invention, cerium (Ce) or zirconium (Zr), or cerium (Ce) and zirconium (Zr) is used either in one or two sequences optionally with calcination in between the addition in order to provide a more stable (more efficient as function of time) method and reactor used to carry out the method. The binder may comprise up to 50% TiO₂. The Cu content (in the catalyst slurry) may suitably be about 1 wt % to 4 wt %, or in the range 1.7 wt % to 3.5 wt %.

In an embodiment of the invention the Cu content (in the slurry) is in the range 2.8 wt %-3.1 wt %. The thickness of the coating may be in the range 10-200 μm, or 20-150 μm such as 30-100 μm, e.g. approximately 50 μm.

It may be an advantage that the Ce is present in the catalyst powder in the range 1-5 wt %, or in the range 2.2 wt % to 3.0 wt %, such as about 2.3 wt %. It may be beneficial that the Zr is present in the catalyst powder in the range 1-3 wt %, or about 1.8 wt %.

The amount of carbonized deposits may depend on the sequence of adding supporting metals. Cu may be added first, and Ce added after a calcination. Alternatively, Cu and Ce may be added in the same sequence without calcination in between, reducing the carbonized deposits significantly. Instead of using Cu, it is possible to use iron (Fe) or Mangan (Mg).

It may be an advantage that the selective catalytic reduction system comprises a programmable logic controller.

In an embodiment of the invention, the amount of injected oil is controlled either by using combined air-oil injection or an “on-off pulse” injection. In case of combined air-oil injection, the air pressure may be adjusted to change the oil amount, as function of the engine load controlled by the programmable logic controller. When the oil is injected in pulses (“on-off”), the amount of injected oil may be controlled by changing the frequency of the pulse. The frequency may be adjusted as function of the engine load controlled by the programmable logic controller. The diesel oil may be injected into a pipe guiding exhaust into the reactor. The pipe may be arranged before the reactor so that the injection takes place outside the reactor. Diesel oil may, however, also be injected into the reactor as long as the exhaust is capable of evaporating the injected diesel oil before the diesel oil enters the layers of the section(s) inside the reactor.

It may be an advantage that the oil is injected in droplets either by using combined air-oil injection or a pulse injection or a combination thereof.

The programmable logic controller may be configured to control the operation following the diesel engine load and rotational speed. The programmable logic controller may include an integrated safety system enabling the programmable logic controller to generate an alert in case that one or more parameters (e.g. pressure or temperature) no longer are within a predefined range.

It may be an advantage that a hardwired safety system is paralleled to the programmable logic controller to ensure the safety in case of programmable logic controller trips.

The selective catalytic reduction system comprises an oil injection system. The oil injection system is arranged and configured to inject oil into the reactor, hereby enabling the above-mentioned NO oxidation process to be carried out. The oil may be injected below the first catalytic layer (section), or both below the first catalytic layer (section) and between two catalytic layers (section). The oil injection system may have a suitable number of nozzles with a certain size.

It may be an advantage that the selective catalytic reduction system comprises a soot blower arranged to provide air (e.g. with fixed time intervals) under the first catalyst layer in every section in order to keep the catalyst entrance surface clean.

The selective catalytic reduction system comprises a reactor in which the above-mentioned NO oxidation process can be carried out. The reactor is configured to house the sections in order to facilitate the NO oxidation process.

The selective catalytic reduction system comprises a number of selective catalytic reduction catalysts provided in separated layers in a first section, wherein the selective catalytic reduction system comprises at least one additional section comprising a number of selective catalytic reduction catalysts in separated layers, wherein the at least one additional section is provided in a non-zero distance from the first section.

The selective catalytic reduction system may comprise one, two or more sections.

In embodiments of the invention, the selective catalytic reduction system comprises three sections.

The selective catalytic reduction system may be used in a two-stroke diesel engine or a four-stroke diesel engine. It may be advantageous that the selective catalytic reduction system is configured to be installed and used in a two-stroke diesel engine or a four-stroke diesel engine for marine purposes.

It may be an advantage that a non-zero distance is within the range 5-500 mm, or between 10-400 mm, such as 20-250 mm is provided between the layers. Hereby, it is possible to facilitate that the required chemical processes will be carried out. The non-zero distance may further depend on the thickness of the catalyst layer or catalyst layers as well as on the catalyst or catalysts applied.

It may be an advantage that the selective catalytic reduction system comprises a number of doors moveably attached to the reactor.

Hereby, the sections can be replaced or turned upside down by accessing the sections through the doors.

The doors may be either rotatably attached to the reactor, slidably attached or detachably attached to the reactor or a structure attached thereto.

In an embodiment of the invention the non-zero distance between the layers is within a range, in which the residence time for moving a gas molecule from one layer to the next layer is between 0.01 seconds to 10.0 seconds, or between 0.1-5.0 seconds, such as 0.2-2.5 seconds.

Hereby, it is possibly to gain the positive effect by applying several layers provided in a distance from each other. Experiments have shown that by choosing non-zero distances defined in the above-mentioned manner, provides a very efficient selective catalytic reduction system.

It may be advantageous that a plate member is provided between at least some of the adjacent sections. The plate member can improve the distribution of oil, hereby providing a more even oil distribution and thus a more effective NOx reduction process.

It may be an advantage that a plate member is provided between the first section and the additional section.

It may be an advantage that a plate member is provided between all adjacent sections.

Hereby, it is possible to provide an even distribution of the oil.

It may be beneficial that the plate member is configured to disperse the oil injected into the interior of the reactor. The plate member may be shaped to guide the evaporated oil radially outwardly to achieve an optimised flow path.

It may be beneficial that the selective catalytic reduction catalysts are arranged in layers each having a thickness within the range 5-200 mm, or 10-150 mm, such as 40-75 mm. It may be an advantage that the reactor comprises one or more sections each comprising several catalyst layers.

It may be advantageous that the selective catalytic reduction catalysts are selected among the following: Ce/Cu-ZSM-5 or Ce—Zr/Cu-ZSM-5, wherein the selective catalytic reduction catalysts are calcinated respectively after Cu adding and after Ce and Zr adding. In one embodiment, the selective catalytic reduction catalysts are dried before being calcinated.

It may be an advantage that the selective catalytic reduction catalysts are selected among the following: Ce/Cu-ZSM-5 or Ce—Zr/Cu-ZSM-5, wherein Cu and Ce and Zr is added at same time and the powder is calcined after the adding of Cu and Ce and Zr.

In one embodiment, Cu, Fe or Mg are added and dried and thereafter Ce and Zr is added and the powder is dried and hereafter calcined.

For both types, TiO₂ may be added to the binder, binding the catalyst powder to the substrate. The substrate consists of either corrugated steel plates or corrugated ceramic plates with 81-256 Cells Per Square Inch (CPSI).

In embodiments of the invention, the selective catalytic reduction system comprises an oxidation catalyst. The oxidation catalyst may be arranged after the selective catalytic reduction system in order to oxidize CO to CO₂ and HC to CO₂ and H₂O.

It may be an advantage that the selective catalytic reduction system comprises a tubular structure extending centrally along the longitudinal axis of the reactor. Hereby, oil can be injected into the central portion of the reactor in order to provide an optimum distribution of the oil.

The tubular structure extends centrally along the longitudinal axis of the lower conical portion of the reactor.

It may be beneficial that the tubular structure extends through the first section and protrudes therefrom.

The tubular structure may be formed as a pipe, e.g. made of metal or a ceramic material.

It may be advantageous that the selective catalytic reduction system comprises a diffuser. Hereby, the diffuser can be used to optimize the distribution of evaporated oil entering the reactor or oil being injected into the reactor (wherein the injected oil is evaporated inside the reactor).

It may be advantageous that the diffuser is arranged at the inlet portion of the tubular structure. The diffuser may be adapted and arranged to diffuse injected oil towards and onto the first section.

It may be an advantage that the selective catalytic reduction system comprises a heat recovering unit. Hereby, it is possible to recover the heat released in the catalysts. The heat can be used for producing steam that might be used for production of drinking water or electricity to be used onboard.

During the process, the temperature increases over the reactor. Up to 75% of the energy content of the reactant can be recovered because of the increase in exhaust temperature after the reactor.

By way of example, a 2500 kW, four-stroke diesel engine, 720 rpm at 75% load with an exhaust temperature of 340° C. will have around 230 kW-heat extra for steam production, with a better quality (higher degree of superheating). The steam might be used for production of drinking water or electricity.

In embodiments of the invention, the system comprises a cooling unit configured to cool down at least a portion of the system. Hereby, it is possible to keep the temperature below a predefined upper temperature limit.

The heat content Qₒᵢₗ in the oil injected can be expressed in a sum of the following components:

Heat loss from the reactor to the ambient: Q_{heat loss}

Heat for increasing inlet temperature to the reactor: Q_{inlet temp increase}

Heat for increasing the temperature over the reactor: Q_{temp over reactor}

Heat loss through the oxidation catalyst: Q_{oxidation}

Accordingly, this can be expressed as:

Qₒᵢₗ=Q_{heat loss}+Q_{inlet temp increase}+Q_{temp over reactor}+Q_{oxidation}

To reduce the ambient Q_{heat loss} the cross section of the reactor may be circular.

Accordingly, in an embodiment of the invention, the reactor comprises a portion that has a circular cross section. It may be an advantage that the reactor comprises a portion that is cylindrical and has a circular cross section.

The method of embodiments of the invention is a method for nitrogen oxides (NOx) reduction, the method comprising the step of using a selective catalytic reduction system and applying diesel oil as reductant for converting nitrogen oxides (NOx) by means of a catalyst into diatomic nitrogen (N₂) and water (H₂O) in the exhaust of a diesel engine, wherein the method comprises the step of providing diesel oil in a reactor, wherein the method comprises the step of carrying out a NOx conversion including a NO oxidation followed by a heterogeneous catalyzing process followed by a homogeneous catalyzing process by applying a number of selective catalytic reduction catalysts provided in a first section having a plurality of layers and a second section comprising a plurality of layers, wherein the distance between the sections is larger than the thickness of the layers.

Hereby, it is possible to carry out an improved selective catalytic reduction process for NOx reduction based on application of diesel oil as reductant.

The selective catalytic reduction process uses diesel oil as reactant.

It may be beneficial that the method comprises the step of cracking the injected oil, carrying out a heterogeneous NOx conversion that causes formation of the radical NH4⁺, wherein the radical NH4⁺ is used for carrying out homogeneous NOₓ conversion.

It may be an advantage that the method comprises the step of providing the second section at a non-zero distance from the first section, wherein the non-zero distance is selected in such a manner that the radical NH4⁺ is allowed to react in the above-mentioned chemical process: NH₄⁺+NO₂⇒N₂+2H₂O, so that the activity is increased.

It may be advantageous that the method is applied for selective catalytic reduction of NOx in an exhaust stream either after a four-stroke diesel engine or between the exhaust receiver and the exhaust turbine(s) on a two-stroke diesel engine.

The method may be applied for selective catalytic reduction of NOx in diesel engines for marine purposes.

### BRIEF DESCRIPTION

Some of the embodiments will be described in detail, with references to the following Figures, wherein like designations denote like members, wherein:

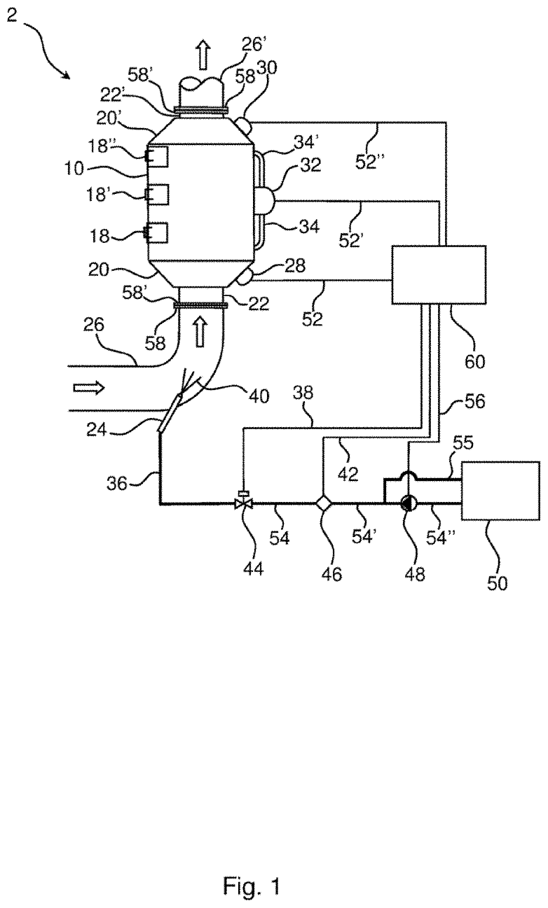

FIG. 1 shows a schematic view of a selective catalytic reduction system according to embodiments of the invention;

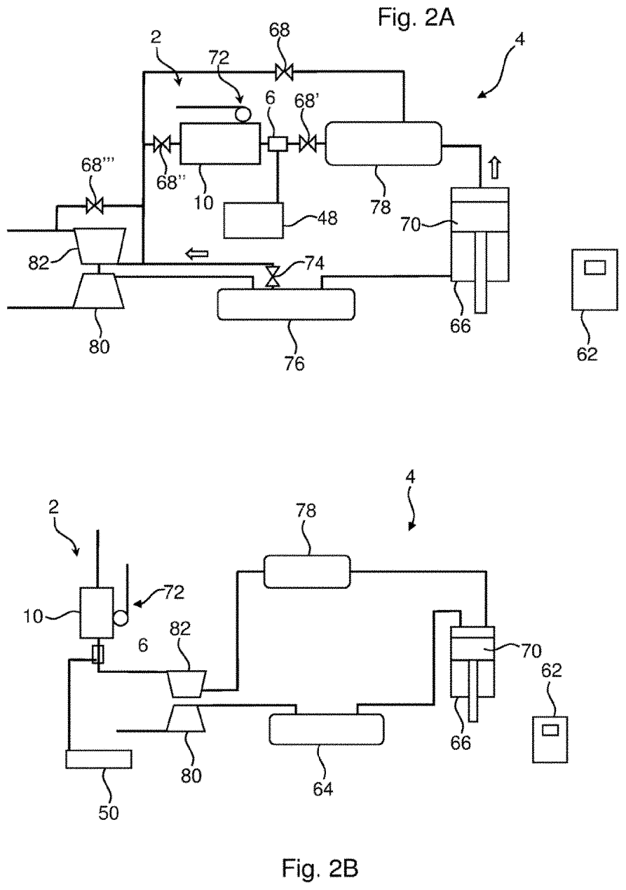

FIG. 2A shows a schematic view of a selective catalytic reduction system according to embodiments of the invention integrated in a two-stroke diesel engine;

FIG. 2B shows a schematic view of a selective catalytic reduction system according to embodiments of the invention integrated in a four-stroke diesel engine;

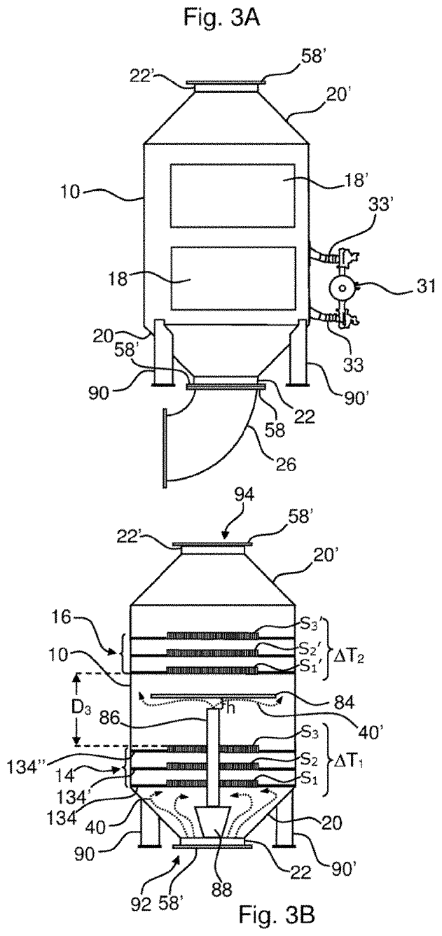

FIG. 3A shows a schematic view of a reactor of a selective catalytic reduction system according to embodiments of the invention;

FIG. 3B shows a schematic, cross-sectional view of a reactor of a selective catalytic reduction system according to embodiments of the invention, wherein the reactor comprises a first section and an additional section provided at a non-zero distance from the first section;

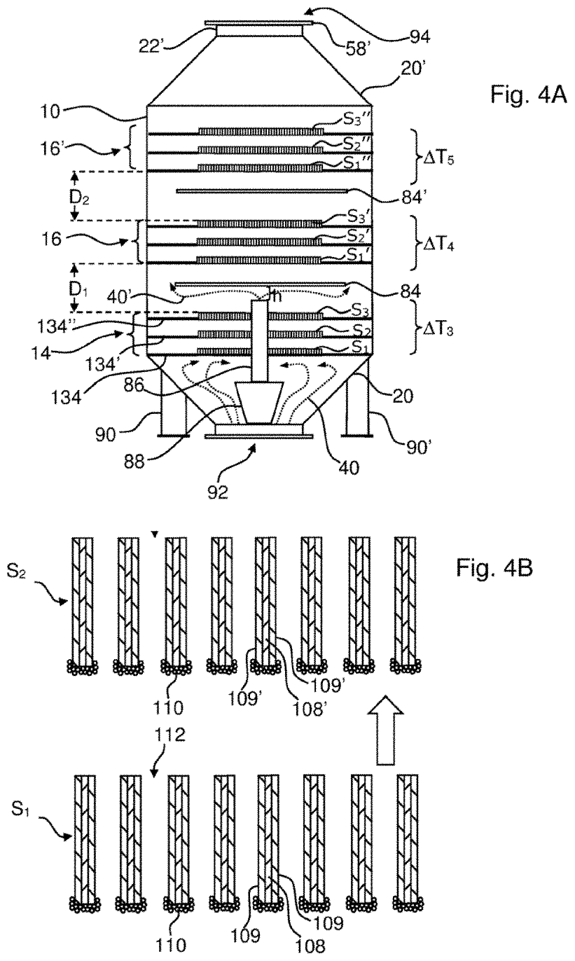

FIG. 4A shows a schematic, cross-sectional view of a reactor of a selective catalytic reduction system according to embodiments of the invention, wherein the reactor comprises a first section, a second section provided in a non-zero distance from the first section and a third section provided at a non-zero distance from the second section;

FIG. 4B shows a schematic, cross-sectional view of a portion of a first section and a second section provided at a non-zero distance from the first section of a reactor of a selective catalytic reduction system according to embodiments of the invention;

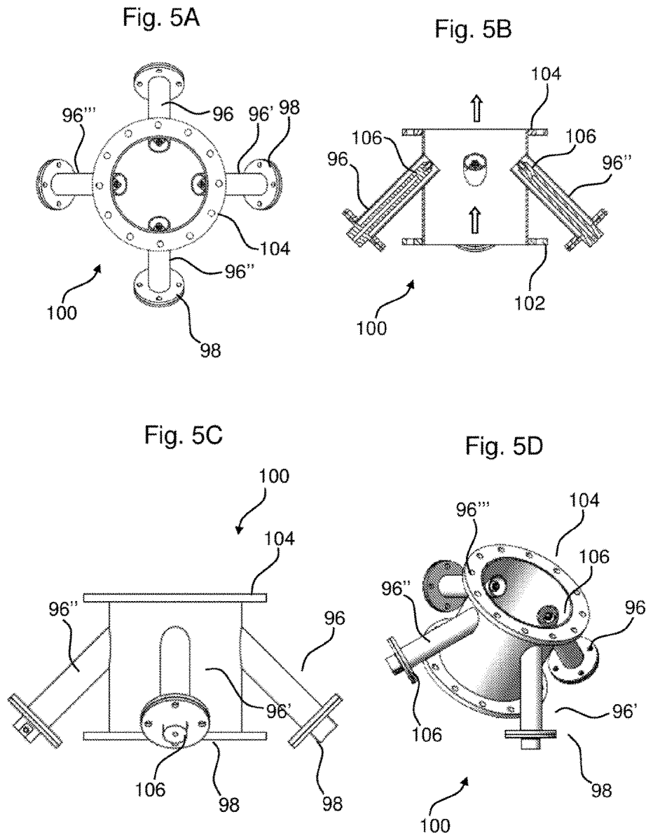

FIG. 5A shows a top view of a manifold of a selective catalytic reduction system according to embodiments of the invention;

FIG. 5B shows a cross-sectional side view of the manifold shown in FIG. 5A;

FIG. 5C shows a side view of the manifold shown in FIG. 5A;

FIG. 5D shows a perspective view of the manifold shown in FIG. 5A;

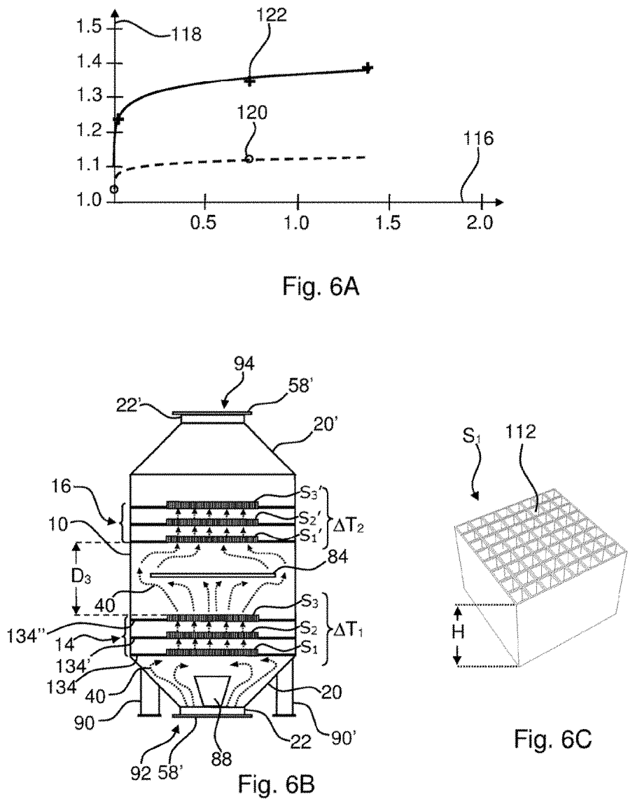

FIG. 6A shows a graph showing the relative activity (two sections relative to one section) as function of the residence time between the sections;

FIG. 6B shows a schematic, cross-sectional view of a reactor of a selective catalytic reduction system according to embodiments of the invention, wherein the reactor comprises a first section and an additional section provided at a non-zero distance from the first section;

FIG. 6C shows a perspective, top view of a layer of a section of a reactor according to embodiments of the invention; Table 1 shows the Cu percentage in slurry, the slurry loading measured in g/L of a various layer configurations;

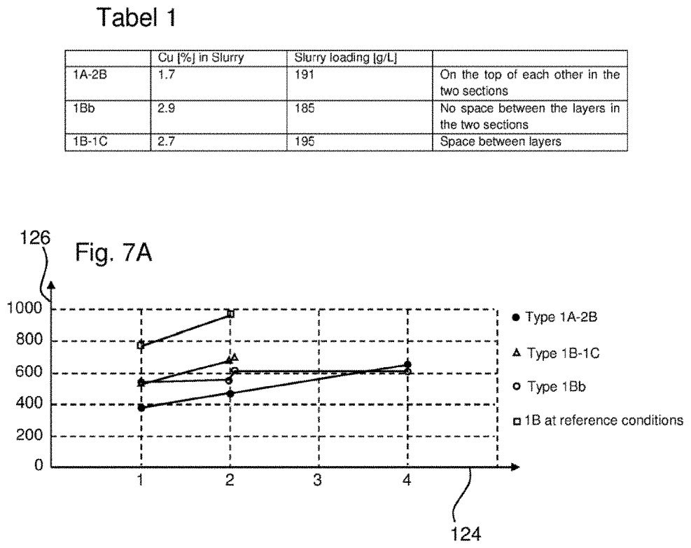

FIG. 7A shows the catalyst activity as function of the Cu content in the layers described in Table 1;

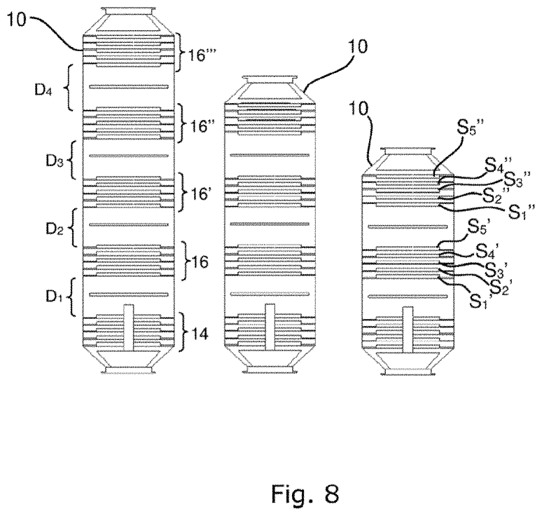

FIG. 8 shows 3 somewhat different embodiments in schematic, cross-sectional view of a reactor of a catalytic reduction system according to embodiments of the invention;

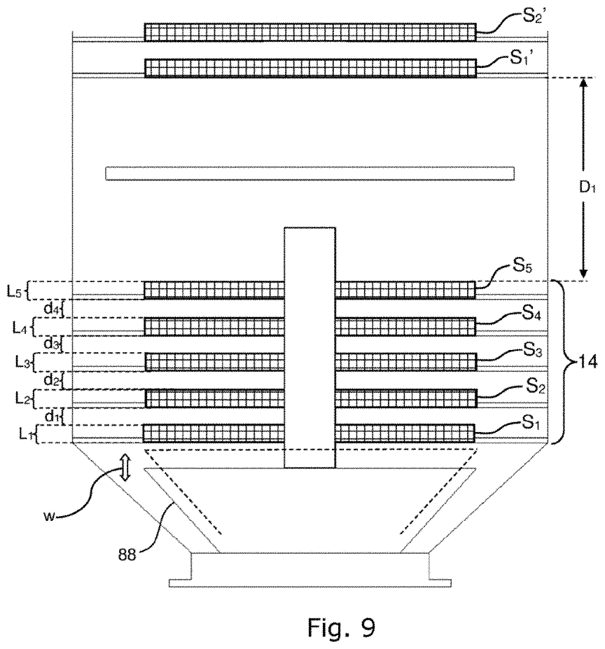

FIG. 9 is an enlarged view of a part of the reactor shown in FIG. 8;

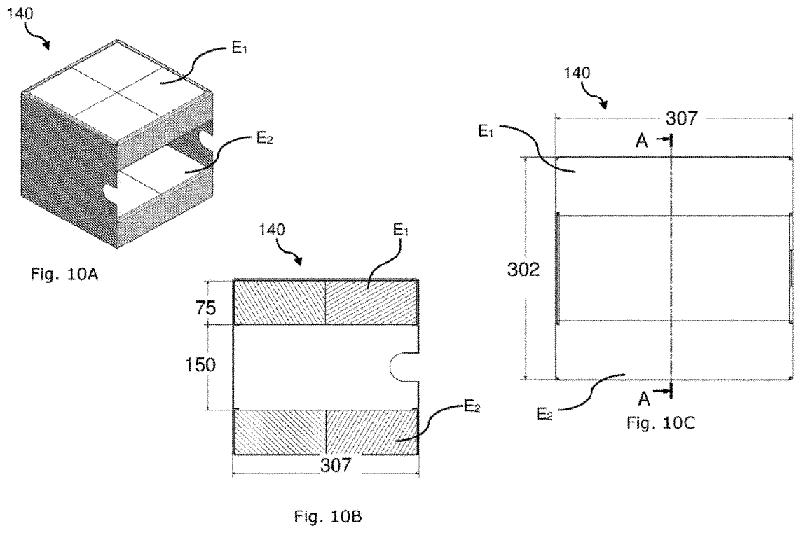

FIG. 10A shows a 3D rendering of an embodiment of a cassette with catalysts for insertion in a reactor,

FIG. 10B is a cross sectional view of the cassette seen in FIG. 10A and

FIG. 10C is a side view of the reactor in FIG. 10A.

### DETAILED DESCRIPTION

Referring now in detail to the drawings for the purpose of illustrating embodiments of the present invention, a selective catalytic reduction system 2 of embodiments of the present invention is illustrated in FIG. 1.

FIG. 1 is a schematic side view of a selective catalytic reduction system 2 according to embodiments of the invention. The selective catalytic reduction system 2 comprises a reactor 10 provided with doors 18, 18′, 18′″ each giving access to a portion of the interior part of the reactor 10. Hereby, it is possible to replace or turn around the sections inside the reactor 10.

The reactor 10 comprises a cylindrical central portion sandwiched between a lower conical portion 20 and an upper conical portion 20′. An end pipe 22 provided with a flange 58 in its distal end is provided in the distal end of the lower conical portion 20. Likewise, an end pipe 22′ provided with a flange 58′ in its distal end is provided in the distal end of the upper conical portion 20′. The doors 18, 18′, 18″ are moveably attached (e.g. rotatably attached or attachably attached) to the central portion of the reactor 10.

It is important to underline that the reactor 10 can be oriented both horizontally and vertically. It may also be possible to arrange the reactor 10 in an inclined orientation so that the reactor is angled relative to both horizontal and vertical.

A pipe 26′ provided with a flange 58 in its proximal end is attached to the end pipe 22′, by fixing the flanges 58, 58′ to each other. Similarly, a bent pipe 26 provided with a flange 58 in its proximal end is attached to the end pipe 22, by fixing the flanges 58, 58′ to each other. It is important to underline that the pipe configuration can be different. In one embodiment according to embodiments of the invention, the pipe 26 may be straight.

An injection unit 24 extends through the wall of the pipe 26 and is configured to inject oil 40 into the pipe 26. The injection unit 24 is configured to inject oil 40 towards the end pipe 22 of the reactor 10. Accordingly, the injected oil 40 will enter the reactor 10, in which the diesel oil is applied as reductant in the selective catalytic reduction system 2.

When oil (in liquid form) is injected into the exhaust in the pipe 26, the diesel oil droplets will evaporate. Accordingly, in an embodiment according to embodiments of the invention, the system does not require a separate oil evaporation unit.

The selective catalytic reduction system 2 comprises a differential pressure sensor 32 connected to a first portion of the reactor 10 by means of a first conduit 34 and to a second portion of the reactor 10 by means of a second conduit 34′. Hereby, the differential pressure sensor 32 is capable of measuring the differential pressure across that part of the reactor 10 that extends between the first portion and the second portion. For practical reasons it may be an advantage that the differential pressure sensor 32 is connected to a lower portion of the reactor 10 by means of the first conduit 34 and to an upper portion of the reactor 10 by means of a second conduit 34′.

Accordingly, the differential pressure sensor 32 can measure the differential pressure across the central portion of the reactor 10, in which the catalysts are arranged. Therefore, the differential pressure sensor 32 is configured to detect when the differential pressure exceeds a predefined pressure level (e.g. 1-1000 mbar, such as 4-500 mbar, or 8-100 mbar, e.g. 10-20 mbar). The selective catalytic reduction system 2 comprises an alert unit configured to generate an alert when the differential pressure exceeds the predefined pressure level.

In embodiments of the invention, two separated pressure sensors are applied to measure the pressure at two different positions of the reactor 10. By comparing the two detected pressures, it is possible to calculate the pressure difference between the two measurement points. Accordingly, the differential pressure sensor 32 may be replaced with two pressure sensors.

The selective catalytic reduction system 2 comprises a first temperature sensor 28 arranged and configured to detect the temperature in the lower (inlet) portion of the reactor 10. The selective catalytic reduction system 2 comprises a second temperature sensor 30 arranged and configured to detect the temperature in the upper (outlet) portion of the reactor 10. By comparing the temperatures detected by means of the first temperature sensor 28 and the second temperature sensor 30, it is possible to measure the temperature increase across the reactor 10.

The selective catalytic reduction system 2 comprises a pump 48 connected to a diesel tank 50 via a pipe 54″. The pump 48 is a pump configured to generate a sufficiently high pressure. The pump 48 is in fluid communication with the injection unit 24. The pump 48 is connected to a flow sensor 46 through a pipe 54′. A control valve 44 is connected to the flow sensor 46 via a pipe 54 and the control valve 44 is connected to the injection unit 24 via a pipe 36. A pipe 55 extends between the pipe 54′ and the tank diesel tank 50. Accordingly, diesel oil can be returned from the pipe 54′ to the tank diesel tank 50. In one embodiment according to embodiments of the invention, the selective catalytic reduction system 2 comprises two pumps 48 (a first pump and a second pump) connected in parallel. Hereby, it is possible to apply the second pump in case that the first pump is malfunctioning, needs to be serviced or be replaced, or vice versa.

A tray (for collecting oil) may be arranged under the injection unit 24. Likewise, a tray may be arranged under the pump for collection of leaking oil. The system 2 may comprise a sensor arranged and configured to generate an alert in case of a sufficiently large leakage.

The selective catalytic reduction system 2 comprises a programmable logic controller 60. The differential pressure sensor 32, the temperature sensors 28, 30, pump 48, the flow sensor 46 and the control valve 44 are connected to the programmable logic controller 60 by means of cables 52, 52′, 52″. However, it is possible to replace this wired connection with a wireless connection (by applying corresponding transmitters and receivers). The programmable logic controller 60 receives the measurements (sensor inputs) detected by the differential pressure sensor 32, the temperature sensors 28, 30, the pump 48, the flow sensor 46 and the control valve 44. The programmable logic controller 60 is configured to control the pump 48 and the control valve 44 on the basis of the sensor inputs of the differential pressure sensor 32, the temperature sensors 28, 30 and the flow sensor 46. The programmable logic controller 60 may be configured to generate an alert when the difference between the detected temperatures exceeds a predefined temperature level or when the difference between the detected temperatures is lower than a predefined temperature level.

FIG. 2A illustrates a schematic view of a selective catalytic reduction system 2 according to embodiments of the invention integrated in a two-stroke diesel engine 4. The two-stroke diesel engine 4 comprises a cylinder 66 with a piston 70. A compressor 80 is arranged to deliver compressed air to a scavenge air receiver 76 that is in fluid communication with the cylinder 66. The exhaust gas leaves the cylinder 66 via a pipe that is connected to an exhaust gas receiver 78. The exhaust gas receiver 78 is connected to an exhaust turbine (expander) 82. The exhaust gas receiver 78 is connected to both the inlet and the outlet of the exhaust turbine 82. A control valve 68′″ is arranged to control the flow through the pipe connecting the gas receiver 78 to the inlet of the exhaust turbine 82. A control valve 68 is arranged to regulate the flow from a pipe leaving the gas receiver 78.

The selective catalytic reduction system 2 comprises an oil pump 48, an oil injector 6 and a reactor 10. The pump 48 is arranged to deliver pressurised oil to the oil injector 6. The oil injector 6 is arranged and configured to inject pressurised oil into the reactor 10. A blower 72 is arranged to blow (compressed) air into the reactor 10. In an embodiment according to embodiments of the invention, the blower 72 is configured to blow air under the first catalyst layer in every section of the catalyst in a predefined manner, with fixed time intervals to keep the catalyst entrance surface clean.

The reactor 10 is arranged between the outlet of the exhaust gas receiver 78 and the exhaust turbine 82. An oil injection system 6 is arranged between the exhaust gas receiver 78 and the reactor 10.

The selective catalytic reduction system 2 comprises a control valve 68′ arranged between the exhaust gas receiver 78 and the oil injection system 6.

In embodiments of the invention, the blower 72 may be an integrated part of the selective catalytic reduction system 2.

In embodiments of the invention, the blower 72 may be a separate unit not being an integrated part of the selective catalytic reduction system 2.

A control valve 68″ is arranged after the outlet of the reactor 10. The control valve 68′ is configured to regulate the flow from the reactor 10.

The scavenge air receiver 76 is connected to the exhaust turbine 82. A control valve 74 is provided between the scavenge air receiver 76 and the exhaust turbine 82. The control valve 74 may be of any suitable type and size.

The selective catalytic reduction system 2 comprises a control unit 62 configured to control a number of units of the selective catalytic reduction system 2. In one embodiment according to embodiments of the invention, the selective catalytic reduction system 2 comprises a control unit 62 configured to control the pump 48, and at least a selection of the control valves 68, 68′, 68″, 68′″ and the brake resistor 74. In an embodiment according to embodiments of the invention, the selective catalytic reduction system 2 comprises a control unit 62 configured to control the pump 48, the control valves 68, 68′, 68″, 68′″ and the brake resistor 74 and the oil injection system 6.

The selective catalytic reduction system 2 may comprise a number of sensors (e.g. as shown in FIG. 1) and an alert unit configured to generate an alert when one or more parameters detected by one or more of the sensors exceed a predefined level or is smaller than a predefined level.

As shown in FIG. 2A, the selective catalytic reduction system 2 is configured for selective catalytic reduction of NOx between the exhaust receiver 78 and the exhaust turbine 82 on a two-stroke diesel engine 2 (e.g. for marine purpose).

FIG. 2B illustrates a schematic view of a selective catalytic reduction system 2 according to embodiments of the invention integrated in a four-stroke diesel engine 4. The four-stroke diesel engine 4 is symbolised by a cylinder 66 with a piston 70. A compressor 80 is arranged to deliver compressed air to an air cooler 30 being in fluid communication with the cylinder 66. The exhaust gas leaves the cylinder 66 via a pipe that is connected to an exhaust gas receiver 78. The exhaust gas receiver 78 is connected to an exhaust turbine 82.

The reactor 10 is arranged after the exhaust turbine 82. The selective catalytic reduction system 2 comprises an oil injector 6 and a reactor 10. A diesel tank 50 is in fluid communication with the oil injector 6. Accordingly, the tank 50 is configured to deliver oil to the oil injector 6. The exhaust turbine 82 is connected to the oil injector 6, which is arranged and configured to inject pressurised oil into the reactor 10. A blower 72 is arranged to blow (compressed) air into the reactor 10. In an embodiment of the invention, the blower 72 is configured to blow air under the first catalyst layer in every section of the catalyst in a predefined manner, with fixed time intervals to keep the catalyst entrance surface clean.

In embodiments of the invention, the blower 72 may be an integrated part of the selective catalytic reduction system 2.

In embodiments of the invention, the blower 72 may be a separate unit not being an integrated part of the selective catalytic reduction system 2.

The selective catalytic reduction system 2 comprises a control unit 62 configured to control a number of units of the selective catalytic reduction system 2. In embodiments of the invention, the selective catalytic reduction system 2 comprises a control unit 62 configured to control the oil injection system 6 as well as one or more structures of the selective catalytic reduction system 2.

The selective catalytic reduction system 2 may comprise one or more control valves (not shown) and the control unit 62 may be configured to control one or more of these control valves. In embodiments of the invention, the control unit 62 is configured to receive one or more signals from one or more sensors and to regulate one or more devices on the basis of the received signal(s). The control unit 62 may be configured to control one or more valves and/or the oil injection system 6 on the basis of temperature and/or differential pressure detections.

The selective catalytic reduction system 2 may comprise a number of sensors (e.g. as shown in FIG. 1) and an alert unit configured to generate an alert when one or more parameters detected by one or more of the sensors exceed a predefined level or is smaller than a predefined level.

FIG. 3A illustrates a schematic view of a reactor 10 of a selective catalytic reduction system according to embodiments of the invention. The reactor 10 comprises a cylindrical central portion provided with a first door 18 arranged in the lower end (with respect to the flow direction indicated by an arrow) of the central portion and a second door 18 arranged in the upper end (with respect to the flow direction indicated by an arrow) of the central portion. The doors 18, 18′ are configured to be opened or removed in order to access the interior of the reactor 10. This enables an easy replacement of the layers (see FIG. 3B) arranged inside the reactor 10.

The central portion is sandwiched between a lower conical portion 20 and an upper conical portion 20′. An end pipe 22 provided with a flange 58′ in its distal end is provided in the distal end of the lower conical portion 20. Likewise, an end pipe 22′ provided with a flange 58′ in its distal end is provided in the distal end of the upper conical portion 20′.

A bent pipe 26 provided with a flange 58 in its proximal end is attached to the end pipe 22, by attachment of the adjacent flanges 58, 58′ to each other. The pipe 26 may have another configuration. The pipe 26 may by way of example be straight.

A pressure tank 31 configured to deliver pressurised air is connected to the reactor 10 by means of a first conduit and a second conduit. A valve 33 is arranged in the first conduit between the pressure tank 31 and the reactor 10, whereas another valve 33 is arranged in the second conduit between the pressure tank 31 and the reactor 10.

The reactor 10 is provided with a first support leg 90, a second support leg 90′ and a third support leg (not shown). The reactor 10 may be applied in a selective catalytic reduction system that comprises a control unit configured to control the one or more oil injectors and/or one or more control valves (not shown). The control unit may be configured to receive information from one or more sensors including the differential pressure sensor 32.

FIG. 3B illustrates a schematic, cross-sectional view of a reactor 10 of a selective catalytic reduction system according to embodiments of the invention. The reactor 10 basically corresponds to the one shown in FIG. 3A. The reactor 10 comprises a cylindrical central portion that is sandwiched between a lower conical portion 20 and an upper conical portion 20′. An end pipe 22 provided with a flange 58′ in its distal end is provided in the distal end of the lower conical portion 20. Likewise, an end pipe 22′ provided with a flange 58′ in its distal end is provided in the distal end of the upper conical portion 20′.

Inside the interior of the cylindrical central portion a first section 14 and an additional section 16 are provided in a non-zero distance D₃ from the first section 14. A plate member is provided between the first section 14 and the additional section 16. The plate member 84 is configured to disperse the oil injected into the interior of the reactor 10.

Each section 14, 16 comprises several layers S₁, S₂, S₃ and S₁′, S₂′, S₃′, respectively. The distance between adjacent layers S₁, S₂, S₃, S₁′, S₂′, S₃′ and the distance D₃ between the first section 14 and the additional section 16 provides time for the generated free radical NH₄⁺ to have an impact through its reaction during the previously mentioned homogeneous catalyzing step:

NH₄⁺+NO₂⇒N₂+2H₂O (5)

Accordingly, by providing a non-zero distance between adjacent layers S₁, S₂, S₃, S₁′, S₂′, S₃′ and between the first section 14 and the additional section 16, it is possible to increase the effect and efficiently of the reactor 10. The distance between adjacent layers S₁, S₂, S₃, S₁′, S₂′, S₃′ and the distance D₃ between the first section 14 and the additional section 16 is selected in such a manner that maximum effect of the free radical NH₄⁺ can be achieved. The distance D₃ is between 5-1000 mm, or in the range 50-500 mm, such as 100-400 mm.

A diffuser 88 is provided in the lower conical portion 20. The diffuser is configured to mix and diffuse the injected oil 40 towards and onto the first layer S₁ of the first section 14.

The exhaust to be treated enters the reactor 10 through the inlet provided in the first end 92, passes the first section 14, the second section 16 and leaves the reactor 10 through the outlet provided in the second end 94. The exhaust carries the injected oil 40 in gaseous form. The gaseous oil 40 is initially guided outwardly by means of the diffuser 88. A closing structure 134, 134′, 134″ extends radially in extension of each layer S₁, S₂, S₃. Accordingly, the closing structures 134, 134′, 134″ force the evaporated diesel oil 40 to pass (axially) through the passages provided in the layer S₁, S₂, S₃.

The first section 14 comprises three layers S₁, S₂, S₃ arranged above each other separated by a gap. Likewise, the second section 16 comprises three layers S₁′, S₂′, S₃′ arranged above each other, wherein a distance is provided between adjacent layers S₁′, S₂′, S₃′.

The layers S₁, S₂, S₃ of the first section 14 and the layers S₁′, S₂′, S₃′ of the second section 16 may form a Ce/Cu-ZSM-5 type catalyst or a Ce—Zr/Cu-ZSM-5 type catalyst.

When a Ce/Cu-ZSM-5 type catalyst is used, the catalyst may be calcinated respectively after Cu adding and after Ce and Zr adding.

When a Ce—Zr/Cu-ZSM-5 type catalyst is used, Cu and Ce and Zr may be added at same time and powder may be calcined after the adding of Cu and Ce and Zr.

For both types, TiO₂ may be added to the binder, binding the catalyst powder to the substrate. The substrate may consist of either corrugated steel plates or corrugated ceramic plates with a CPSI (Cells Per Square Inch) in the range 81-256.

The layers S₁, S₂, S₃ of the first section 14 and the layers S₁′, S₂′, S₃′ of the second section 16 may have essentially the same thickness. The thickness of each layer may be 5-500 mm, or 10-250 mm such as 40-150 mm, e.g. 75 mm.

In an embodiment of the invention, the layer S₁ has a thickness of 5-500 mm, or 10-250 mm such as 40-150 mm, e.g. 75 mm. In an embodiment of the invention, the layer S₂ has a thickness of 5-500 mm, preferably 10-250 mm such as 40-150 mm, e.g. 75 mm. In an embodiment of the invention, the layer S₃ has a thickness of 5-500 mm, or 10-250 mm such as 40-150 mm, e.g. 75 mm.

In an embodiment of the invention, the layers S₁′, S₂′ and S₃′ have a thickness of 5-500 mm, or 10-250 mm such as 40-150 mm, e.g. 75 mm.

In an embodiment of the invention, the layers S₁, S₂, S₃ are of equal type and dimension.

In embodiments of the invention, the layers S₁, S₂, S₃ are of different equal type and/or thickness.

A plate member 84 is arranged between the first section 14 and the second section 16. A tubular structure 86 formed as a centrally arranged tube extends along the longitudinal axis of the lower conical portion 20 of the reactor 10. Evaporated oil 40′ is introduced into the space between the two sections 14, 16. The distal end of the tubular structure 86 is provided in a distance h to the plate member 84. The plate member 84 is configured and arranged to guide the evaporated diesel oil 40′ radially towards the periphery of the reactor 10, from which the evaporated diesel oil 40′ is guided towards the first layer S₁′ of the second section 16.

The selective catalytic reduction system according to embodiments of the invention may comprise an additional oxidation catalyst reactor (not shown) configured to oxidize CO to CO₂ and HC to CO₂ and H₂O. The additional oxidation catalyst reactor may be arranged after the reactor 10.

Under the first catalyst layer S₁ (arranged closest to the inlet 92 of the reactor 10) in the first section 14 and the first catalyst layer S₁ in the second section 16, air may be blown with fixed time intervals to keep the catalyst entrance surface clean. This may be done by means of a blower (as illustrated in FIG. 2A and FIG. 2B).

The catalysts of the sections 14, 16 ensure three integrated catalyzing processes including:
Cracking of oil;
Heterogeneous NOx conversion and formation of radicals used for a following reaction;
Homogeneous NOx conversion downstream the catalyst.

The temperature increases across the first section 14. This temperature increase ΔT₁ is indicated in FIG. 3B. Likewise, the temperature increases across the second section 16. This temperature increase ΔT₂ is also indicated in FIG. 3B.

In an embodiment of the invention, the selective catalytic reduction system comprises a waste heat recovering system arranged after the reactor 10. Hereby, the waste heat recovering system can recover the heat released in the catalysts of the reactor 10.

The recovered heat may be used for producing steam for production of drinking water or electricity (that may be used onboard if the selective catalytic reduction system is applied for selective catalytic reduction of NOx in an exhaust stream in a marine diesel engine).

FIG. 4A illustrates a schematic, cross-sectional view of a reactor 10 of a selective catalytic reduction system according to embodiments of the invention. The selective catalytic reduction system comprises a reactor 10 provided with a first section 14, a second section 16 provided in a non-zero distance D₁ from the first section 14 and a third section 16′ provided in a non-zero distance D₂ from the second section 16. The reactor 10 basically corresponds to the one shown in FIG. 3A and FIG. 3B. The reactor 10 comprises a cylindrical central portion that is sandwiched between a lower conical portion 20 and an upper conical portion 20′. An end pipe 22 provided with a flange 58′ in its distal end, is provided in the distal end of the lower conical portion 20. Likewise, an end pipe 22′ provided with a flange 58′ in its distal end is provided in the distal end of the upper conical portion 20′.

Inside the interior of the cylindrical central portion, however, a first section 14 and an additional section 16 are provided in a non-zero distance D₁ from the first section 14. A second plate member 84′ is provided in a non-zero distance D₂ between the additional (second) section 16 and the third section 16′. The plate members 84, 84′ are configured to disperse the oil 40′ injected into the interior of the reactor 10.

The distance D₁ between the first section 14 and the additional section 16 as well as the distance between adjacent layers S₁, S₂, S₃, S₁′, S₂′, S₃′ provides time for the generated free radical NH₄⁺ to have an impact through its reaction with nitrogen dioxide (NO₂) forming diatomic nitrogen gas (N₂) and water (H₂O). Likewise, the distance D₂ between the additional section 16 and the third section 16′ as well as the distance between adjacent layers S₁″, S₂″, S₃″ provides time for the generated free radical NH₄⁺ to have an impact through the above-mentioned reaction with nitrogen dioxide (NO₂).

By providing a non-zero distance D₁, D₂ between the adjacent sections 14, 16, 16′ and between adjacent layers S₁, S₂, S₃, S₁′, S₂′, S₃′, S₁″, S₂″, S₃″, it is possible to improve the effect and efficiently of the reactor 10. The distances may be selected in such a manner that maximum effect of the free radical NH₄⁺ can be achieved. The distances D₁, D₂ may be between 5-1000 mm, or in the range 50-500 mm, such as 100-400 mm. In an embodiment of the invention, the distances D₁, D₂ are equal. The distance between adjacent layers S₁, S₂, S₃, S₁′, S₂′, S₃′, S₁″, S₂″, S₃″ may be between 5-1000 mm, or in the range 25-500 mm, such as 50-400 mm.

A tubular structure 86 extends centrally along the longitudinal axis of the lower conical portion 20 of the reactor 10. The tubular structure 86 extends through the first section 14 and protrudes therefrom. A diffuser 88 is arranged at the inlet portion of the tubular structure 86. The diffuser 88 is adapted and arranged to mix and diffuse injected oil towards and onto the first layer C₁ of the first section 14.

Exhaust from the engine in which the selective catalytic reduction system is installed, enters the reactor 10 through the inlet provided in the first end 92, passes the first section 14, the second section 16, the third section 16′ and leaves the reactor 10 through the outlet provided in the second end 94.

The first section 14 comprises three layers S₁, S₂, S₃ arranged above each other, wherein adjacent layers are axially spaced from each other. The second section 16 comprises several layers S₁′, S₂′, S₃′ arranged above each other and are spaced from each other. The third section 16′ comprises several layers S₁″, S₂″, S₃″ spaced from each other.

The sections 14, 16, 16′ may be of the same type as the sections explained with reference to FIG. 3B. The sections 14, 16, 16′ may have the same geometry (including thickness) as the sections explained with reference to FIG. 3B.

The temperature increases across all sections 14, 16, 16′. The temperature increase ΔT₃, ΔT₄, ΔT₅ across each of the segments 14, 16, 16′, is indicated in FIG. 4A.

In an embodiment of the invention, the selective catalytic reduction system comprises a waste heat recovering system (not shown) arranged after the reactor 10. Hereby, the waste heat recovering system can recover the heat released in the catalysts of the reactor 10. Accordingly, the recovered heat may be used for producing steam for production of drinking water or electricity (that may be used onboard if the selective catalytic reduction system is applied for selective catalytic reduction of NOx in an exhaust stream in a marine diesel engine).

FIG. 4B illustrates a schematic, close-up view of a portion of a first layer S₁ and a second layer S₂ provided in a non-zero distance from the first layer S₁. The adjacent layers S₁, S₂ may be layers of the same section of adjacent sections of a reactor of a selective catalytic reduction system according to embodiments of the invention. Each layer S₁, S₂ comprises a structure provided with a plurality of passages 112, 112′ extending through the layer S₁, S₂. Each layer S₁, S₂ comprises a substrate 108, 108′ at least partly, or completely, covered by a catalyst powder 109, 109′ attached to the substrate as a coating.

The cracking process represents the first process step inside the reactor. The diesel oil used as reactant is injected into the exhaust as small droplets upstream (in the direction indicated by the arrow) the catalyst layer of the first layer S₁. The injection of oil is carried out in such a manner that minimum 80% of the oil droplets are evaporated before reaching the first catalyst layer S₁. The selective catalytic reduction system is configured to evenly disperse the oil into the exhaust.

The evaporated oil is cracked on the surface of the catalyst layer S₁. Accordingly, cracked oil 110 will be present on the distal portion of the substrate 108, 108′. A portion of the oil may flow un-cracked towards the passages 112, 112′ of the first catalyst layer S₁ and the second catalyst layer S₂. Due to the increased temperature (as explained with reference to FIG. 4A), only a minimum of the injected oil is passing through the system.

When the selective catalytic reduction system is used in marine engines, the diesel oil contains relative long-chained hydrocarbon (HC) connections. These connections are cracked to short-chained HC connections during the catalyst process. Accordingly, the short-chained HC connections will be short enough to enter the catalyst layer and convert NO to N₂ and H₂O and further produce radicals (NH4+). The chemical reactions (of the NOx conversion) are show in the following.

The NO oxidation carried out may be expressed as:

NO+1/2O₂⇒NO₂ (1)

NO+NO₂+2H⁺⇒2NO++H₂O (2)

The heterogeneous catalyzing carried out may be expressed as:

2C₄H₈+10O₂+2NO⁺⇒N₂+2CO+6CO₂+8H₂O (3)

C₃H₆+NO⁺+2.5O₂⇒NH₄⁺+CO+2CO₂+H₂O (4)

The homogeneous catalyzing carried out may be expressed as:

NH₄⁺+NO₂⇒N₂+2H₂O (5)

FIG. 5A illustrates a top view of a manifold 100 of a selective catalytic reduction system according to embodiments of the invention. FIG. 5B illustrates a cross-sectional side view of the manifold 100 shown in FIG. 5A. FIG. 5C illustrates a side view of the manifold 100 shown in FIG. 5A and FIG. 5D a perspective view of the manifold 100 shown in FIG. 5A.

The manifold 100 comprises a cylindrical tubular body portion that is provided with a first flange 102 in the inlet end of the manifold 100 and a second flange 104 in the opposite outlet end of the manifold 100. The flanges 102, 104 are configured to be attached to an adjacent pipe (not shown) provided with a matching flange.

The manifold 100 comprises four connection pipes 96, 96′, 96″, 96′″ evenly distributed along the circumference of the manifold 100. The connection pipes 96, 96′, 96″, 96′″ are angled relative to the longitudinal axis of the cylindrical tubular body portion.

Each connection pipes 96, 96′, 96″, 96′″ is provided with a flange 98 in its distal end. A nozzle 106 extends through the interior of each connection pipes 96, 96′, 96″, 96′″. The nozzles 106 are arranged and configured to inject oil into the upper, central portion of the manifold 100.

FIG. 6A illustrates two graphs each showing the relative activity 118 (two sections relative to one section) as function of the residence time 116 (measured in seconds) between the sections for the homogeneous NOx reduction process as indicated in the above-mentioned equation (5).

FIG. 6A illustrates two examples of how the NOx reduction activity 118 varies as function of distance between two layers (shown as the time 116 for a gas particle to move from one section to the other section). When one layer is placed in a very small distance from the adjacent layer, the increase in activity 118 is marginal, whereas when the distance is increased, the activity is increased. The activity 118, however, depends on the catalyst specification (the layers making up the section).

The uppermost graph comprises points 122 representing the activity when two layers of different types are applied. The activity is measured relative to a reference activity in a reactor comprising only a single layer.

The lowermost graph comprises points 120 representing the activity when the catalyst layer thickness is low. The activity is measured relative to the activity in a reactor comprising only a single section.

It can be seen that the relative activity 118 is very low compared to the situation wherein the catalyst layer thickness is larger. Both graphs increase as function of residence time 116. Accordingly, it is possible to achieve an increased efficiency of the selective catalytic reduction system according to embodiments of the invention by introducing two sections being provided in a non-zero distance from each other.

The lowermost graph, however, illustrates that the effect of several layers is minimal when the catalyst layer is thin. Accordingly, the catalyst layer exceeds a predefined minimum layer thickness. The predefined minimum catalyst layer thickness may depend on the relative content of Cu, Fe or Mg.

FIG. 6B illustrates a schematic, cross-sectional view of a reactor 10 of a selective catalytic reduction system according to embodiments of the invention, wherein the reactor 10 comprises a first section 14 and an additional section 16 provided at a non-zero distance D₃ from the first section 14. The reactor 10 basically corresponds to the one shown in FIG. 3B. The reactor 10, however, does not comprise a tubular structure.

FIG. 6C illustrates a perspective, top view of a layer S₁ of a section of a reactor according to embodiments of the invention. The layer S₁ is provided with a plurality of longitudinal extending passages 112. The passages 112 have rectangular, square, cross sections, or of equal size. Each passage 112 is, at least partly, covered with a catalyst coating. In an embodiment (not show), corrugated plates are applied. In this embodiment, the passages are not rectangular.

The height H of the layer S₁ may be in the range 20-300, such as 40-150 mm, e.g. 60-120 mm.

Table 1 illustrates the Cu percentage in slurry, the slurry loading measured in g/L of a first layer configuration called 1A-1B, a second layer configuration called 1Bb and a third layer configuration called 1B-1C. In the first layer configuration, 1A-1B, the layers are arranged on the top of each other in the two sections. In the second layer configuration, 1Bb, there is no space between the layers in two sections, whereas the third layer configuration, 1B-1C, a space between adjacent layers.

FIG. 7A illustrates the catalyst activity 126 (NOx reduction measured in ppm) as function of the Cu content in the layers described in Table 1. FIG. 7A depicts the NOx reduction as function of the number of layers 124. A layer, 1B, arranged under predefined reference conditions is indicated with open squares. The first layer configuration, 1A-1B is indicated with solid circles, the second layer configuration 1Bb is indicated with open circles, whereas the third layer configuration, 1B-1C is indicated with open triangles.

FIG. 7A illustrates that 1, the layers in the first layer configurations 1A-2B having a 1.7% Cu content, can be placed on top of each other. This, however, provides a relative low activity 126. Increased Cu loading increases the activity 16, however, also the production of radical's, explained with reference to the previously mentioned equation (4) and (5), which has to enter a homogeneous reduction process after the catalyst not inside the catalyst.

In FIG. 7A, the layers in the second layer configuration, 1Bb are placed on top of each other in two adjacent sections. FIG. 7A shows, that with the relative high Cu content (2.9%) there is no outcome of adding an extra layer on top of the first layer in each section.

Type 1B and 1C are placed in one section with space in between. An increase in activity due to the homogeneous catalysing process after the catalyst can be observed.

FIG. 8 discloses 3 different reactors 10, where the reactor far left comprises five sections 14, 16, 16′, 16″ and 16′″ separated by distances D₁, D₂, D₄ and D₄. The reactor depicted centrally in FIG. 8 has 4 sections, where the reactor at the far-right side of the figure has 3 sections. In each section in the reactors shown in FIG. 8 there are 5 spaced apart layers S₁, S₂, S₃, S₄, S₅. (See FIG. 9). In other respects, the reactors shown in FIG. 8 are similar to the reactors depicted in FIGS. 3B and 4A.

In FIG. 9 an enlarged view of a section 16 with accompanying distance D₁ is provided. Layers S₁-S₅ are disclosed and the distances d₁-d₄ between the layers are also indicated. As seen the distance D₁ is significantly larger than each one of the thicknesses L₁-L₅ of the layers S₁-S₅. This corresponds to the distance relations previously mentioned. The distances d₁-d₄ indicated between the layers, may be in the order of the thickness L₁-L₅ of the individual layers.

In the embodiment shown in FIG. 9 an arrow w indicates a movement which the diffuser 88 may perform in order to get closer to or further away from the first section 14 in a reactor 10. By adjusting this distance correctly, the time allowed between injection of oil 40 and the contact between oil and the first layer of the first section may be either reduced or diminished.

FIGS. 10A, 10B an 10C shows an embodiment wherein the layers E₁ and E₂ are shaped differently than in the previously mentioned embodiments. Each of the layers E₁ and E₂ are basically made from the same material as previously mentioned layers S₁-S₅; S₁′-S₅′; S₁″-S₅″ and are also structured with through going canals running straight through the thickness from one side to an opposed side. However, as seen in FIG. 10A, each of the layers E₁, E₂ are composed of square blocks, which are assembled in a 2×2 flat upper layer E₁, and a 2×2 lower layer E₂. Upper layer E₁ and lower layer E₂ are assembled in a nearly cubic shaped cassette 140. FIG. 10B shows a sectional view of a cubic shaped cassette along line A-A in FIG. 10C.

An example of measures for a cassette adapted for a specific catalytic reduction system is provided in FIG. 10C and FIG. 10B. As can be seed in FIG. 10B a distance of 150 is donated between the layers E₁ and E₂, whereas each of the layers has a thickness of 75. The nearly cubic cassette has a height of 302 and a measure 307 along each side. The provided measures are given in mm; but could well be given in inches or scaled with another scaling size according to the use of the cubic cassette. The cassette 140 is particularly well suited for systems where regular exchange of the cassettes are foreseen, and where shipment of cassettes from stock to place of use will frequently be undertaken.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

### LIST OF REFERENCE NUMERALS

2 Selective catalytic reduction system
4 Diesel engine
6 Oil injection system
10 Reactor
11, 11′, 11″ Selective catalytic reduction catalyst
12, 12′, 12″ Selective catalytic reduction catalyst
14 First section
16, 16′ Additional section
18, 18′, 18″ Door
20, 20′ Conical portion
22, 22′ End pipe
24 Injection unit
26, 26′ Pipe
28 Temperature sensor
30 Temperature sensor
31 Pressure tank
32 Differential pressure sensor
33, 33′ Valve
34, 34′ Conduit
36 Pipe
38 Cable
40 Oil
42 Cable
44 Control valve
46 Flow sensor
48 Pump
50 Diesel tank
52, 52′, 52″ Cable
54, 54′, 54″ Pipe
55 Pipe
56 Cable
58, 58′ Flange
60 Programmable Logic Controller (PLC)
62 Control unit
64 Air cooler
66 Cylinder
68, 68′, 68″, 68′″ Valve
70 Piston
72 Blower
74 Control valve
76 Scavenge air receiver
78 Exhaust gas receiver
80 Compressor
82 Exhaust turbine (expander)
84, 84′ Plate member
86 Tubular structure
88 Diffuser
90, 90′ Support leg
92 First end
94 Second end
96, 96′, 96″, 96′″ Connecting pipe
98 Flange
100 Manifold
102 Flange
104 Flange
106 Nozzle
108, 108 Substrate
109, 109′ Catalyst
110 Cracked diesel oil
112, 112′ Passage
114 Graph
116 Residence time between the catalyst layers
118 Relative activity (two layers relative to one layer)
120 Point
122 Point
124 Number of layers
126 Activity (NOx reduction [ppm])
134, 134′, 134″ Closing structure
140 Cubic cassette
D₁, D₂, D₃ Distance
d₁, d₂, d₃, d₄ Distance
ΔT₁, ΔT₂, ΔT₃ Temperature increase
ΔT₄, ΔT₅ Temperature increase
S₁, S₂, S₃, S₄, S₅ Layer of selective catalytic reduction catalysts
S₁′, S₂′, S₃′, S₄′, S₅′ Layer of selective catalytic reduction catalysts
S₁″, S₂″, S₃″ Layer of selective catalytic reduction catalysts
S₄″, S₅″, E₁, E₂ Layer of selective catalytic reduction catalysts
L₁, L₂, L₃, L₄, L₅ Thickness
h Distance
H Height
W arrow

1. A selective catalytic reduction system applying diesel oil as reductant for converting nitrogen oxides (NOx) through a NO reduction process of a catalyst into diatomic nitrogen (N₂) and water (H₂O) in a diesel engine, wherein the selective catalytic reduction system is configured to be installed and used in a two-stroke or a four-stroke diesel engine for marine purposes, wherein the selective catalytic reduction system comprises:
an oil injection system, a reactor; and
a number of selective catalytic reduction catalysts provided in at least a first section comprising a plurality of layers and in a second section arranged downstream of the first section, comprising a plurality of layers, wherein the reactor is configured to house the sections in order to facilitate the NO oxidation process, wherein the distance between the sections is larger than the thickness of the layers, wherein a non-zero distance between the layers is within a range, in which the residence time for moving a gas molecule from one layer to the next layer is between 0.01 seconds to 10.0 seconds.

2. The selective catalytic reduction system according to claim 1, wherein the residence time is between 0.1-5.0 seconds.

3. The selective catalytic reduction system according to claim 1, wherein the residence time is 0.2-2.5 seconds.

4. The selective catalytic reduction system according to claim 1, wherein the selective catalytic reduction system comprises a first section comprising two or more layers provided in a non-zero distance from each other.

5. The selective catalytic reduction system according to claim 1, wherein the selective catalytic reduction system comprises one or more additional sections each comprising two or more layers provided in a non-zero distance from each other, wherein the reactor is configured to house the one or more additional sections in order to facilitate the NO oxidation process.

6. The selective catalytic reduction system according to claim 1, wherein a plate member is provided between at least some of the adjacent sections.

7. The selective catalytic reduction system according to claim 1, wherein the selective catalytic reduction catalysts are arranged in layers each having a thickness within the range 5-1000 mm, or in the range 50-500 mm, or 100-400 mm.

8. The selective catalytic reduction system according to claim 1, wherein the selective catalytic reduction catalysts are selected among the following: Ce/Cu-ZSM-5, Ce—Zr/Cu-ZSM-5, Ce/Fe-ZSM-5 or Ce—Zr/Fe-ZSM-5, Ce/Mg-ZSM-5 or Ce—Zr/Mg-ZSM-5, wherein the selective catalytic reduction catalysts are calcinated respectively after Cu, Fe or Mg adding and after Ce and Zr adding.

9. The selective catalytic reduction system according to claim 1, wherein the selective catalytic reduction catalysts are selected among the following: Ce/Cu-ZSM-5, Ce—Zr/Cu-ZSM-5, Ce/Fe-ZSM-5 or Ce—Zr/Fe-ZSM-5, Ce/Mg-ZSM-5 or Ce—Zr/Mg-ZSM-5, wherein Cu, Fe or Mg and Ce and Zr is added at same time and the powder is calcined after the adding of Cu, Fe or Mg and Ce and Zr.

10. The selective catalytic reduction system according to claim 1, wherein the selective catalytic reduction system comprises a tubular structure extending centrally along the longitudinal axis of the reactor, wherein the tubular structure extends through the first section and protrudes therefrom.

11. The selective catalytic reduction system according to claim 1, wherein the selective catalytic reduction system comprises a diffuser.

12. The selective catalytic reduction system according to claim 1, wherein the selective catalytic reduction system comprises a heat recovering unit.

13. A method for nitrogen oxides reduction, the method comprising the step of using a selective catalytic reduction system configured to be installed and used in a two-stroke or a four-stroke diesel engine for marine purposes and applying diesel oil as reductant for converting nitrogen oxides of a catalyst into diatomic nitrogen and water in a diesel engine, wherein the method comprises the step of injecting evaporated diesel oil into the exhaust gas entering a reactor, the method comprises the step of carrying out a NOx conversion including a NO oxidation followed by a heterogeneous catalyzing process followed by a homogeneous catalyzing process by applying a number of selective catalytic reduction catalysts provided in a first section having a plurality of layers, and in a second section arranged downstream from the first section, the second section comprising a plurality of layers, wherein the distance between the sections is larger than the thickness of the layers, wherein a non-zero distance between the layers is within range, in which the residence time for moving a gas molecule from one layer to the next layer is between 0.01 seconds to 10.0 seconds.

14. The method according to claim 13, wherein the residence time is between 0.1-5.0 seconds.

15. The method according to claim 13, wherein the residence time is 0.2-2.5 seconds.

16. The method according to claim 13, wherein the method comprises the step of cracking at least a portion of the evaporated diesel oil, carrying out a heterogeneous NOx conversion that causes formation of the radical NH4⁺, wherein the radical NH4⁺ is used for carrying out homogeneous NOₓ conversion.

17. The method according to claim 13, wherein the method comprises the step of providing the at least one additional section in a non-zero distance from the first section.

18. The method according to claim 13, wherein the method is applied for selective catalytic reduction of NOx in an exhaust stream either after a four-stroke diesel engine or between the exhaust receiver and the exhaust turbine(s) on a two-stroke diesel engine.
